(19) United States
(12) Patent Application Publication
(10) Pub. No.: US 2017/0265452 A1
(43) Pub. Date: Sep. 21, 2017

(54) TRAP COVER AND INDICATOR

(71) Applicant: LEASUREACRES LLC, Sherwood, OR (US)

(72) Inventor: Kevin Jay Leasure, Sherwood, OR (US)

(21) Appl. No.: 15/071,019

(22) Filed: Mar. 15, 2016

(51) Int. Cl. A01M 23/24; A01M 23/26

(52) U.S. Cl. CPC A01M 23/245; A01M 23/26

(57) ABSTRACT

Briefly, embodiments of a cover for use with a trap, such as a burrowing rodent trap, may comprise a coupling to attach to a movable element of a burrowing rodent trap, an indicator to indicate a state of the burrowing rodent trap, and a housing to cover a hole into which the burrowing rodent trap is disposed, the indicator to be movable with respect to the housing.

### BACKGROUND

1. Field

This disclosure relates to equipment that may be used in conjunction with trapping nuisance animals, such as moles or other underground burrowing rodents.

2. Information

Certain nuisance animals, such as moles and other underground burrowing rodents, may represent a constant source of irritation for homeowners, golf course operators, park groundskeepers, and others. Thus, a variety of traps or like devices may be utilized to control the infestation and the spread of underground burrowing rodents. In some instances, such as if a homeowner or groundskeeper is attempting to control an infestation of moles, the homeowner or groundskeeper may dig a hole in an area, such as a sodded area, a flower bed, an orchard, a vineyard, a garden or other food-growing area, etc., and place a mole trap within an underground mole run. The trap may then be covered with dirt, sod, other material, for example, so as to maintain darkness within the mole run. Consequently, as the mole, or like animal, approaches the trap, the trap may be triggered, which may, in turn, capture the mole or like animal.

However, especially for some homeowners, park groundskeepers, and golf course operators, or the like, who may be responsible for maintaining relatively expansive grassy areas, for example, it may be problematic and/or inconvenient to regularly walk or even hike out to an infested area simply to check the status of a buried trap, such as a mole trap. This may be especially true in rainy climates, which may require a homeowner, for example, to dress in rain gear one or more times per day solely for the purpose of checking the state of remotely-located burrowing rodent traps, for example.

### BRIEF DESCRIPTION OF DRAWINGS

Claimed subject matter is particularly pointed out and/or distinctly claimed in the concluding portion of the specification. However, both as to organization and/or method of operation, together with objects, features, and/or advantages thereof, claimed subject matter may be understood by reference to the following detailed description if read with the accompanying drawings in which:

FIG. 1A is a perspective view of an example trap cover and indicator placed above a burrowing rodent trap in an Open state, according to an embodiment;

FIG. 1B is a perspective view of an example trap cover and indicator placed above a burrowing rodent trap in a Closed state, according to an embodiment;

FIG. 2A-2B are cutaway views of an example trap cover and indicator placed in an area, according to an embodiment;

FIG. 3A-3C are cutaway views of example trap covers and electronics modules, according to embodiments;

FIG. 4 is a schematic of circuit elements utilized by an example trap cover and indicator, according to an embodiment;

FIG. 5A is a side view showing external dimensions of an example trap cover and indicator, according to an embodiment;

FIG. 5B is a cutaway view showing internal dimensions of an example trap cover and indicator, according to an embodiment;

FIG. 6 is a perspective view of an example trap cover and indicator incorporating a retainer for storage of hand tools, according to an embodiment; and

FIG. 7 is a perspective view of an example trap cover and indicator along with a lid for storage of items, according to an embodiment.

Reference is made in the following detailed description to accompanying drawings, which form a part hereof, wherein like numerals may designate like parts throughout the figures to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter.

### DETAILED DESCRIPTION

Reference throughout this specification to “one example,” “one feature,” “one embodiment,” “an example,” “a feature,” “an implementation,” or “an embodiment” means that a particular feature, structure, or characteristic described in connection with the feature, example, or embodiment is included in at least one feature, example, or embodiment of claimed subject matter. Thus, appearances of the phrase “in one example,” “an example,” “in one implementation,” “an implementation,” “an embodiment,” or “in one embodiment” in various places throughout this specification are not necessarily all referring to the same feature, example, or embodiment. Particular features, structures, or characteristics may be combined in one or more examples, features, or embodiments. The terms “user” and “individual” may be used interchangeably herein.

As previously mentioned herein, nuisance animals, such as moles and other underground burrowing rodents, may represent a source of irritation and annoyance for groundskeepers, golf course operators, and/or homeowners, or the like. In some instances, in an effort to reduce or eliminate an infestation of nuisance animals, such as moles or other underground burrowing rodents, one or more varieties of trap or other capture device may be deployed. In general, deployment of a trap, such as a mole trap, for example, may involve digging a shallow hole in an area, such as a sodded area, a flowerbed, an orchard, a vineyard, a garden or other food-growing area, etc., and placing the trap within an underground mole run. In general, due to the hidden aspect of a trap, it may be useful for a homeowner, for example, to check the trap one or more times, often in a single day, to determine if the trap has been triggered and/or an animal has been captured. On occasion, to ascertain if a mole trap has been triggered, a homeowner, groundskeeper, or like individual may, for example, be required to unearth the trap and visually inspect the trap. Under certain circumstances, such as if a trap has not been triggered, unearthing and/or visually inspecting a trap may give rise to the trap closing, which, at times, may result in the trap pinching or injuring one or more of the individual's fingers, for example.

Accordingly, certain embodiments of a trap cover and indicator may reduce or eliminate a need or circumstance for a homeowner or groundskeeper, for example, to approach and/or manipulate a trap for the purposes of determining if a burrowing rodent, such as a mole or the like, has been captured. Thus, a park groundskeeper, for example, may merely observe the trap cover and indicator from a remote location, perhaps utilizing binoculars, for example, to determine if a burrowing rodent has been captured. As discussed below, in particular embodiments, a colored flag, for example, may be utilized, such as to signify that a trap has transitioned from an Open state to a Closed state to indicate that a burrowing rodent has been captured.

As will be described, in certain embodiments, a trap cover and indicator may employ, for example, an illuminating device so as to permit a groundskeeper, or the like, to determine a state (e.g., Open, Closed, etc.) of a trap from a significant distance and/or during evening hours. An embodiment of a trap cover and indicator utilizing an illuminating device may enable, for example, a golf course operator to view a wide area, such as an entire fairway, for example, and to quickly determine a state of several traps.

In particular embodiments, a trap cover and indicator may be equipped with a wireless transmitter, which may report, such as at occasional or periodic intervals, for example, that a trap has transitioned from an Open state to a Closed state indicating capture of a burrowing rodent. In one or more embodiments, a groundskeeper, for example, may enter or select an identification code, or like parameter, to be transmitted by a wireless transmitter of a trap cover and indicator, which may uniquely identify a particular trap cover and indicator. Responsive to a change of state of a trap, a wireless transmitter may transmit a signal comprising an identification code, or like parameter, which may notify a groundskeeper, for example, that a particular trap has likely captured a burrowing rodent. In an embodiment, a wireless transmitter may be capable of retransmitting an identification code until a groundskeeper, for example, resets or deactivates the transmitter.

In particular embodiments, if a trap cover and indicator is to be situated in a sodded area, such as above a hole dug in a lawn or golf course green to access a tunnel utilized by a burrowing rodent, for example, the trap cover and indicator may comprise one or more recessed areas, as illustrated in the figures, which may provide storage of a contiguous portion of removed sod. In other embodiments, one or more recessed areas may be utilized, at least in part, for storage of any other material, and claimed subject matter is not limited in this respect. In such embodiments, recessed areas may be horizontally oriented so as to permit contiguous portions of removed sod, just as a possible example, to remain exposed to sunlight as well as to irrigation and/or rainwater, so as to maintain the removed sod in a viable condition. At times, after capture of a burrowing rodent, a hole may be refilled, for example, and removed sod may be replaced atop the refilled hole. It should be noted that in other embodiments, one or more horizontally-oriented recessed areas may be suitable for storage of other materials, and claimed subject matter is not limited in this respect.

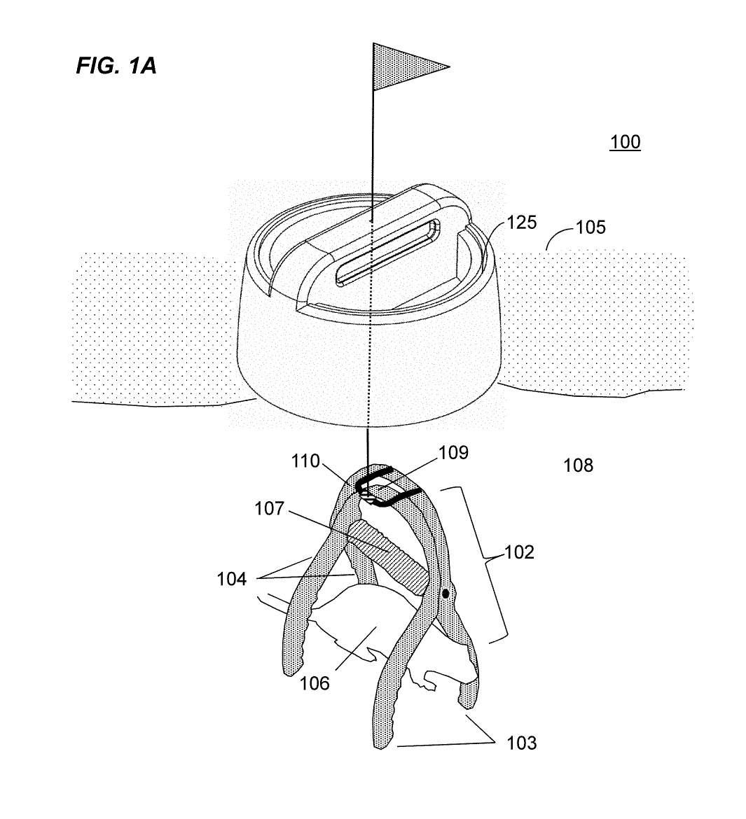

FIG. 1A is a perspective view of a trap cover and indicator placed above a burrowing rodent trap in an Open state, according to an embodiment 100. In FIG. 1, a trap cover and indicator may be placed in a sodded area, such as area 105, which may correspond to a homeowner's lawn, a grassy surface of a park, a golf course fairway, or any other area, grassy or otherwise, capable of providing habitat for burrowing rodents. In other embodiments, area 105 may represent a portion of a flower bed, a portion of a vineyard, a portion of an orchard, a portion of a garden or other food-growing area, for example, or may represent any other habitat that may be prone to an infestation of burrowing rodents. In some instances, to prepare the trap cover and indicator to be deployed, a homeowner or groundskeeper, for example, may utilize a hand trowel or other gardening instrument to provide access to, for example, a mole run or other type of tunnel in underground area 108 that is at least occasionally traversed by a burrowing rodent.

In an embodiment, trap 102 may utilize a pair of pincers, such as pincers 103 and 104, which may operate to transition from an Open state, such as shown in FIG. 1A, to a Closed state responsive to triggering by burrowing rodent 106. In such embodiments, if burrowing rodent 106 enters an area between pincers 104 and 106, the burrowing rodent may make contact with a trigger, which may bring about closure of pincers 103 and 104, such as shown in FIG. 1B. In particular embodiments, sufficient force to bring about closure of pincers 103 and 104 may be provided by spring 107. Spring 107 may store potential energy in the form of torsion to be applied to pincers 103 and 104 responsive to triggering of trap 102.

In particular embodiments, if trap 102 has been set to the Open state, indicating the trap's ability to capture a burrowing rodent, coupling 110 may attach, affix, or otherwise be securable, to a movable element of the burrowing rodent trap. In embodiments, coupling 110 may comprise a hook, clamp, magnet, or other type of fastening device, which may, for example, attach or affix to a safety bar of a pincer-type trap 102. In one possible embodiment, coupling 110 may attach or affix to a safety bar, such as safety bar 109 of FIG. 1A. Responsive to transitioning of trap 102 from an Open state to a Closed state, safety bar 109 may be movable so as to change position from a first orientation to a second orientation such as, for example, from a predominantly horizontal orientation, such as shown in FIG. 1A, to a predominantly vertical orientation, such as shown in FIG. 1B. In other embodiments, coupling 110 may attach or affix to a different type of movable element, such as a safety latch, for example, which may undergo a movement or change in position, for example, responsive to a change of state of trap 102. In other embodiments, coupling 110 may merely rest atop, for example, a movable element and may be permitted to fall under the influence of gravity (e.g., in a downward direction) responsive to movement of the movable element to indicate triggering of trap 102.

FIG. 1B is a perspective view of an example trap cover and indicator placed above a trap in a Closed state, according to an embodiment 150. In particular embodiments, after trap 102 has been placed in a Closed state, for example in response to capture of burrowing rodent 106, movable safety bar 109, for example, may be movable in the direction of gravity (e.g., in a downward direction). It should be noted that although embodiments 100 and 150 utilize a coupling securable to a movable element that changes from a substantially horizontal position to a substantially vertical position in response to closing of pincers 103 and 104, claimed subject matter is intended to embrace all types of covers for use with traps comprising one or more movable elements which may change position responsive to transition of a trap from an Open state to a Closed state.

In accordance with certain embodiments, housing 125 may be at least partially buried in area 105, for example, so as to remain in position during inclement weather, such as wind, rain, and so forth. To secure the trap cover and indicator of embodiments 100 and 150 atop area 105, a homeowner or groundskeeper may grip housing 125 utilizing his or her fingertips to engage recessed area 127. Embodiments of a trap cover and indicator may comprise any suitable plastic, metal, or composite material, for example, having suitable strength so as to permit a homeowner or groundskeeper to apply downward pressure, such as by way of grasping or gripping recessed area 127, so as to at least partially bury housing 125 within area 105. In particular embodiments, the trap cover in indicator may comprise an opaque material, which may restrict sunlight or other light that may be incident on a mole run so as to encourage burrowing animals 106, for example, to traverse between pincers 103 and 104.

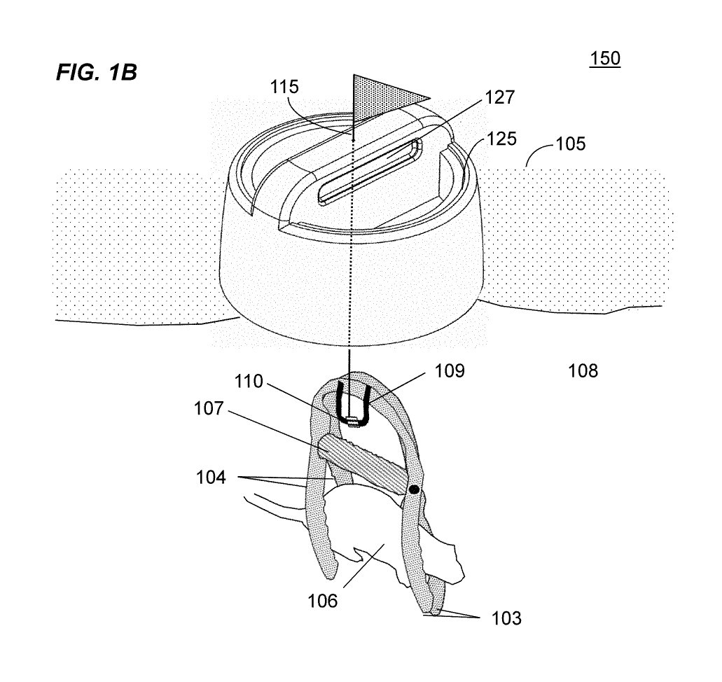

FIGS. 2A-2B are cutaway views of a trap cover and indicator placed in an area, according to an embodiment 200. As previously mentioned with respect to FIGS. 1A-1B, coupling 110, which may be affixed, attached, or otherwise securable to a movable element of trap 102, operate to allow shaft 115 to change position in concert with safety bar 109, and to fall in a downward direction. Responsive to shaft 115 moving in a downward direction, for example, shaft 115, and flag 120 which may attach to shaft 115, may be drawn in a direction of gravity (e.g., downward) towards housing 125, such as shown in FIG. 2B (embodiment 250). As previously mentioned, in other embodiments, coupling 110 may fasten or attach to a different portion of a burrowing rodent trap, and claimed subject matter is not limited in this respect. Housing 125 may incorporate an opening, such as vertically-oriented sleeve 135, which may provide lateral support to shaft 115 so as to permit sliding of shaft 115 in a direction of gravity (e.g., upward and downward directions) while limiting lateral (e.g. side-to-side) motion.

As previously mentioned, in particular embodiments, lowering of shaft 115 and flag 120 may be indicative of an easily-observable approach toward determining, perhaps from a remote location, that a burrowing rodent trap, for example, located beneath the trap cover and indicator has transitioned from an Open state to a Closed state. In other embodiments, shaft 115 may couple to a different portion of a burrowing rodent trap other than to safety bar 109, for example, so long as the portion of the burrowing rodent trap to which shaft 115 has been coupled undergoes sufficient movement so as to permit shaft 115 to become decoupled from a movable element of the burrowing rodent trap, which may thereby permit shaft 115, and flag 120, to retract or move in a direction of gravity towards housing 125.

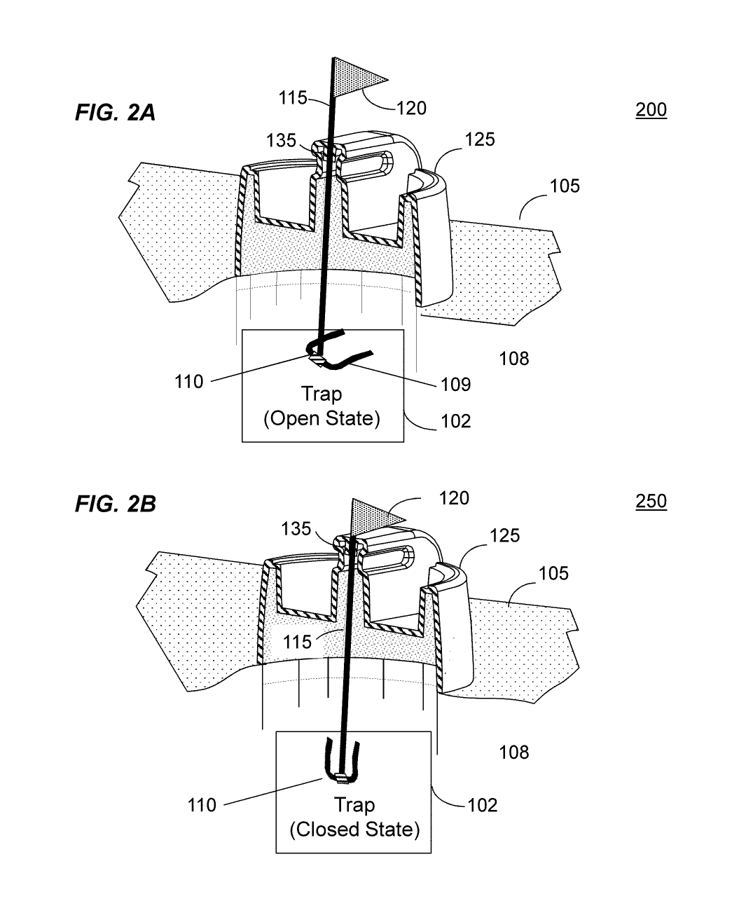

FIGS. 3A-3C are cutaway views of example trap covers and electronics modules, according to embodiments. In embodiment 300 (FIG. 3A), a shaft 315 comprises a predominantly insulating material, such as plastic, for example at locations other than a predominantly or substantially conductive area 320. Thus, if a trap, such as trap 102 of FIG. 1A, remains in an Open state, contacts 340, which may be disposed within or adjacent to vertically-oriented sleeve 135 (as shown in FIG. 2A, for example), may not make contact with predominantly insulating portions of shaft 315, such as shown in FIG. 3A. Accordingly, in one possible embodiment, a voltage present across contacts 340 may not result in sufficient current to illuminate an illuminating element. Thus, in turn, illuminating element 335, which may comprise an incandescent lamp, light emitting diode, or other appropriate light source, may remain extinguished. In an embodiment, an electronics module 330 may be mounted to a surface of the housing 125 and may comprise simple electronics such as a battery placed in a weather-resistant enclosure, for example.

In embodiment 325 (FIG. 3B), shaft 315 is shown as retracted or moved in the direction of housing 125. In an embodiment, such retraction or movement of shaft 315 towards housing 125 may correspond to a trap, such as trap 102 of FIG. 1, transitioning from an Open state to a Closed state, which may indicate capture of a burrowing rodent. Accordingly, responsive to transitioning of a burrowing rodent trap, predominantly conductive area 320 may be brought into contact with contacts 340, which may function as a switch to permit an electrical current to flow between electrical contacts 340. Responsive to current flow between electrical contacts 340, electronics module 330 may generate sufficient voltage and current to activate illuminating element 335. Thus, one or more of illuminating element 335 and flag 120 may be viewed from a remote location, during daylight or evening hours, to indicate that a mole or other type of burrowing rodent has been captured by trap 102.

In embodiment 350 (FIG. 3C), shaft 315 is shown as retracted or moved in the direction of housing 125. In FIG. EC, electronics module 360 may operate to detect that shaft 315 has been retracted or moved toward housing 125 by sensing a current flow, for example, between contacts 340. Electronics module 360 may comprise suitable radiofrequency (RF) circuitry and processing resources to enable transmission of a wireless signal from antenna 370 responsive to detection of a current flow from a first of contacts 340 to a second of contacts 340. Thus, a trap cover and indicator of embodiment 350 may allow a homeowner or groundskeeper to receive a message, via a wireless communications channel, which may indicate that a burrowing rodent has been captured by trap 102. In one possible embodiment, electronics module 360 may periodically or occasionally repeat a transmission to indicate capture of a burrowing rodent. In another possible embodiment, electronics module 360 may be powered by solar panel 380, which may operate to collect solar energy for storage in a battery or other type of energy storage facility. In another possible embodiment, solar panel 380 may be integrated into housing 125.

It should be noted that although the embodiments of FIGS. 3A-3C utilize simple electrical contacts, such as contacts 340, to switch or activate, for example, illuminating element 335, other embodiments may employ other types of switches and/or switching circuitry. For example, in one possible embodiment, a downward force on shaft 315, which may be brought about by coupling 110 moving in a downward direction, may transition any other type of contact switch from an Open state to a Closed state, for example, which may activate illuminating element 335 or give rise to electronics module 360 transmitting a signal from antenna 370.

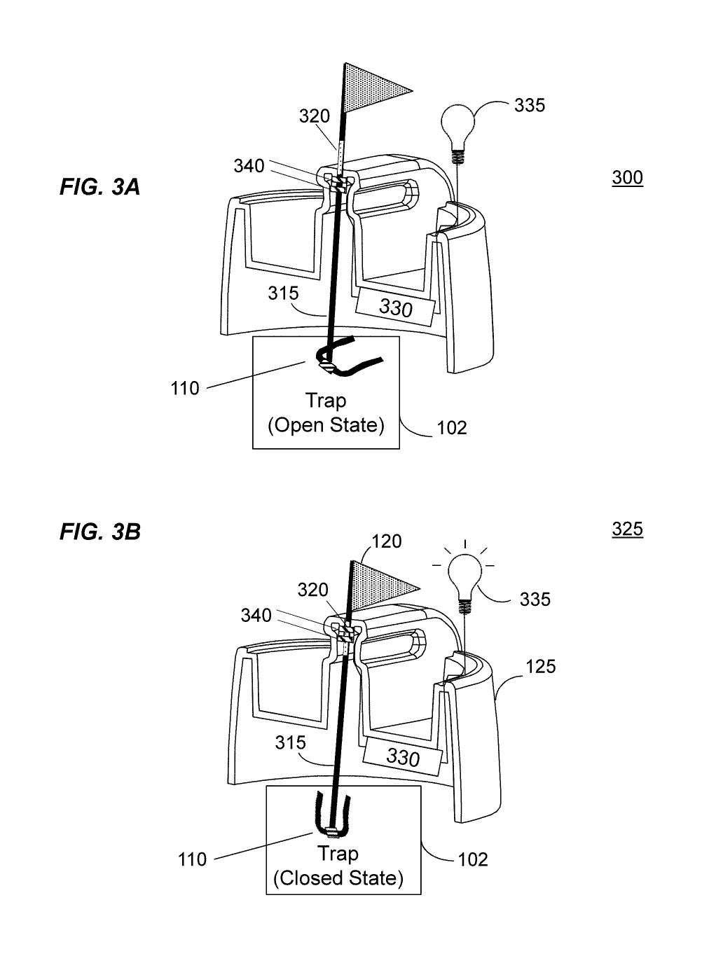

FIG. 4 shows an example schematic of circuit elements utilized by a trap cover and indicator, according to an embodiment 400. A trap cover and indicator may comprise, for example, power supply 405 (such as a battery or solar-electric panel), detector 410, indicator 420, trap coupling 425, timer 430, and code selector 435. In embodiment 400, power supply 405 of FIG. 4, may comprise a battery or other type of energy storage facility. Power supply 405 may provide prime power to detector 410, which may operate to detect the Open/Closed state of a burrowing rodent trap, such as trap 102 of FIG. 1, by way of a trap coupling 425, as discussed above. Responsive to detection, such as by way of movement of trap coupling 425 to indicate that a burrowing rodent trap has transitioned from an Open state to a Closed state, detector 410 may activate indicator 420. Indicator 420 may comprise an illuminating element, a wireless transmitter, or may comprise any other type of indicator. Activation of an illuminating element or wireless transmitter, for example, may indicate to a homeowner or a groundskeeper, for example, that a burrowing rodent has been captured.

In an embodiment in which indicator 420 comprises a wireless transmitter, timer 430 may facilitate or support occasional or periodic transmission of a signal to inform a groundskeeper, for example, that a burrowing rodent trap has transitioned from an Open state to a Closed state. Signals may be transmitted at intervals of, for example, every minute, every 5 minutes, every 10 minutes, every hour, and so forth, and claimed subject matter is not limited in this regard. In a particular embodiment, an identification code selector, such as code selector 435 of embodiment 400, may allow a user, such as a groundskeeper, for example, to enter or select a unique identification code. Thus, a groundskeeper, for example, placing burrowing rodent traps in a number of locations may enter or select a unique identification code utilized by individual trap cover and indicator units. Accordingly, if a groundskeeper, for example, receives a wireless signal conveying a particular identification code, such as 1234, as one example, the groundskeeper may be capable of identifying the precise trap cover and indicator that has transitioned from an Open state to a Closed state.

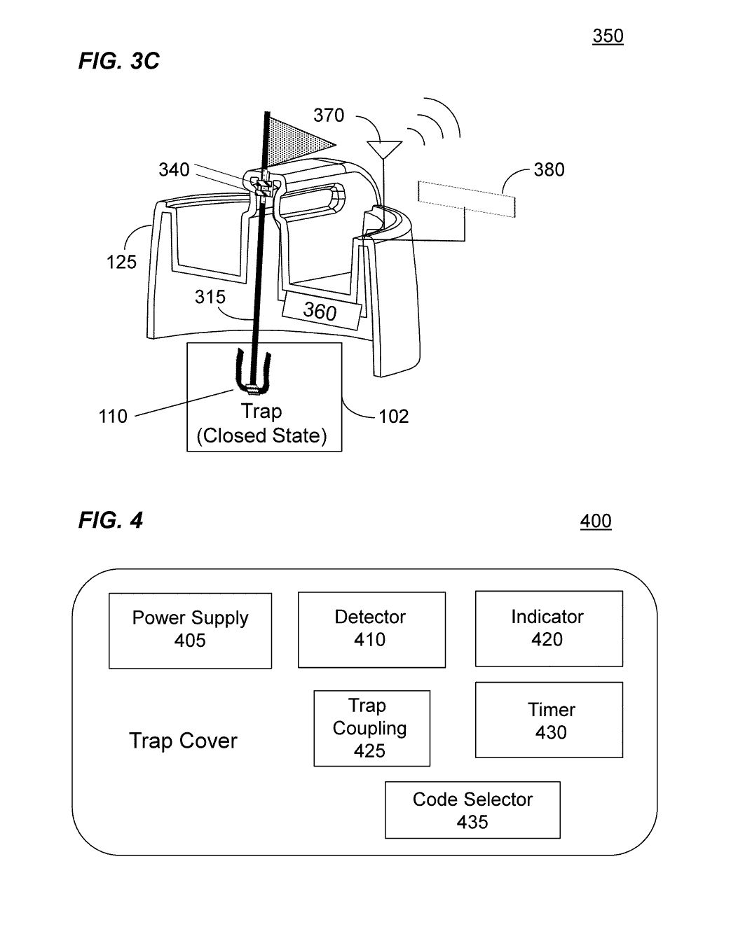

FIG. 5A is a side view showing external dimensions of a particular example of a trap cover and indicator, according to an embodiment 500. It should be pointed out that the dimensions illustrated in FIGS. 5A and 5B merely represent example dimensions, and claimed subject matter is not limited to any particular size of trap cover and indicator. As shown in FIG. 5A, a trap cover and indicator may comprise a diameter of approximately 21.6 cm. However, in embodiments, a trap cover and indicator may comprise an approximately circular footprint comprising a diameter from approximately 15.0 cm to 35.0 cm. In particular embodiments, a trap cover and indicator may comprise a rectangular, oblong, or elliptically-shaped footprint comprising, for example, a width approximately in the range of 15.0 cm to 35.0 cm, and claimed subject matter is not limited in this respect. Additionally, although shown as comprising a height of 15.24 cm, a trap cover and indicator may vary in height from approximately 5.0 cm to approximately 30.0 cm, for example. Further, although a handle or grip portion may be shown as comprising a height of 3.81 cm and a width of 4.1 cm, a trap cover and indicator may comprise a grip portion that varies in size from a height of, for example, as of approximately 1.0 cm and a width of approximately 2.0 cm to a height of approximately 8.0 cm and a width of approximately 10.0 cm.

FIG. 5B is a cutaway view showing internal dimensions of an example trap cover and indicator, according to an embodiment 550. As shown in FIG. 5B, a trap cover and indicator may include storage areas 555, having a depth of approximately 5.1 cm and a width of approximately 6.1 cm, which may be suitable for storing sod or other type of material removed from, for example, a flower bed, an orchard, vineyard, and so forth. It should be noted, however, that storage areas 555 may comprise varying dimensions, such as a depth of approximately 2.0 cm to approximately 9.0 cm and a width of approximately 3.0 cm to approximately 10.0 cm, and claimed subject matter is not limited in this respect. A storage area may comprise a diameter of approximately 17.3 cm, but may vary from 8.0 cm to 25 cm, for example.

The trap cover and indicator of embodiment 550 may include an opening that transitions to vertically-oriented sleeve 135 having a diameter of approximately 0.24 cm, so as to slidably engage shaft 115, for example, shown in FIG. 1A. However, a vertically oriented sleeve may vary from a diameter of approximately 0.1 cm to approximately 1.0 cm, or larger and claimed subject matter is not limited in this respect. Further, vertically-oriented sleeve 135 may comprise a shape other than a circular shape, so as to accommodate shafts other than shafts comprising circular cross sections. The trap cover and indicator of embodiment 550 may comprise a plastic material having a thickness of 0.51 cm but may vary from approximately 0.25 cm to 1.0 cm, for example. The trap cover in indicator of embodiment 550 may comprise a lip that surrounds storage area 555 having a width of approximately 0.89 cm and a height of approximately 0.38 cm. However, in embodiments, a lip surrounding a storage area may comprise a width of approximately 0.4 cm to 1.5 cm and a height of approximately 0.25 cm to 1.0 cm, for example. The trap cover and indicator of embodiment 550 may include a recessed area to permit a homeowner or groundskeeper to grip the unit for removal and installation in an area. A recessed area may comprise a depth of approximately 0.64 cm, but may vary from 0.3 cm to 1.0 cm, for example.

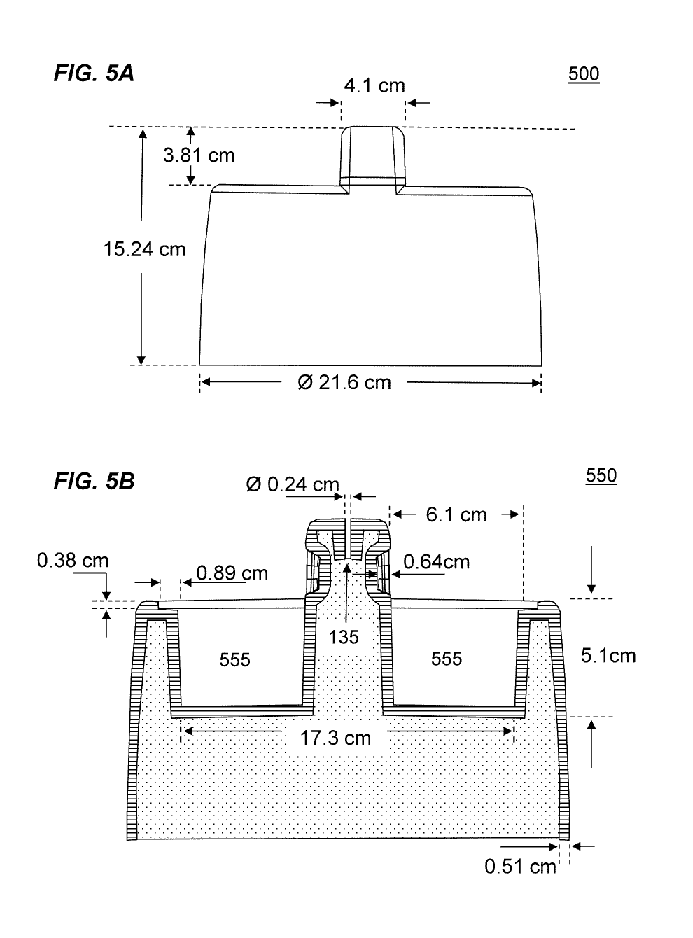

FIG. 6 is a perspective view of an example trap cover and indicator incorporating a retainer for storage of hand tools, according to an embodiment 600. Although embodiment 600 illustrates a retainer 610 utilized for storage of a hand trowel, in other embodiments additional tools may be accommodated such as pliers, brushes, utensils useful in setting a trap to an Open state, and so forth. Further, in particular embodiments, retainer 610 may comprise a yoke, such as for storage of a hand trowel, but may comprise a quiver or other type of retainer suitable for storage of, for example, a hand trowel or other utensils useful, for example, in setting a trap. It should be noted that claimed subject matter is intended to embrace trap cover and indicators comprising various types of retainers useful in storing a variety of tools.

Further, it should also be noted that although there are five of spikes 620 shown in FIG. 6, embodiments may include any number of spikes to assist a homeowner, groundskeeper, or any other individual in securing the trap cover and indicator above a hole in an area, such as a sodded area. In other embodiments, housing 125 may utilize one or more eyelets in lieu of spikes 620. In an embodiment, eyelets may permit installation of the trap cover by driving one or more stakes through the eyelets and into an area, such as a sodded area.

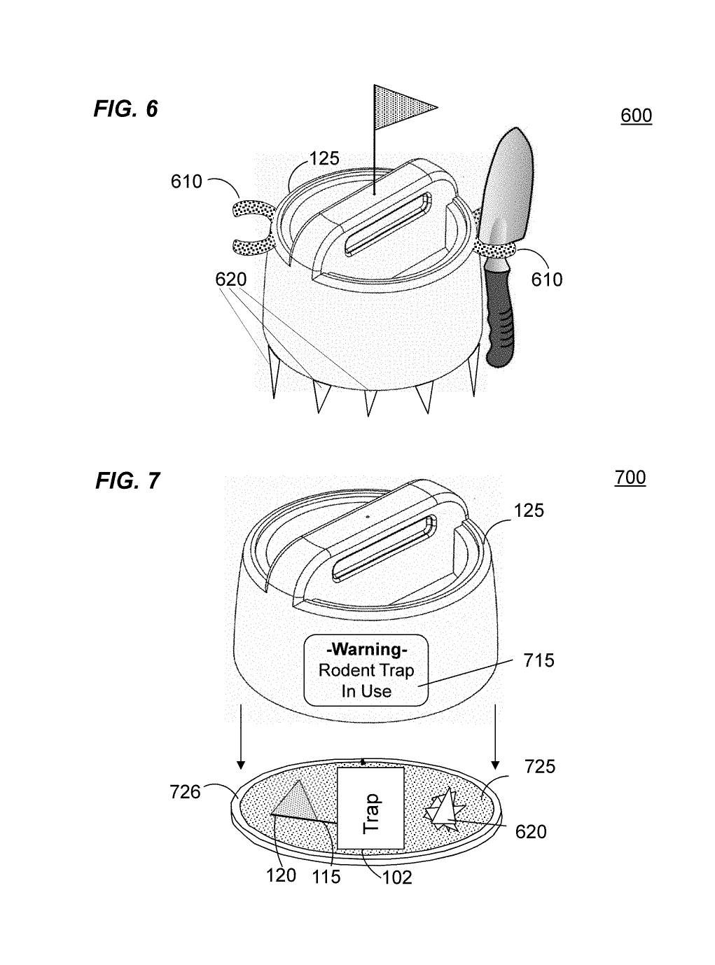

FIG. 7 is a perspective view of an example trap cover and indicator along with a lid, which may serve to enclose an interior volume, such as the whole volume, for example, of the trap cover and indicator for storage of items according to an embodiment 700. In the embodiment of FIG. 7, lid 725 may operate to form a substantially airtight seal around the base of housing 125. In embodiments, lid 725 may comprise a lip, such as lip 726, for example, or other feature to permit the lid to be removably secured to the housing 125. Use of lid 725 to enclose an interior volume of the trap may permit, for example, convenient storage of trap 102, shaft 115, flag 120 and one or more of spikes 620. In embodiments, lid 725 removably secured to housing 125, may permit storage of additional items, or items other than those shown in FIG. 7, such as hand trowels, tools which may be utilized to set trap 102 to an Open state, for example, and claimed subject matter is not limited in this respect. As shown in FIG. 7, housing 125 may comprise a warning label 715, which may serve to notify other homeowners, groundskeepers, park personnel, gardeners, vineyard and orchard operators, and so forth, of the presence of a burrowing rodent trap.

In the present patent application, terms such as “over” and “under” are understood in a similar manner as the terms “up,” “down,” “top,” “bottom,” “upward,” “downward,” and so on, as previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. For example, fabrication of a trap cover and indicator, orientation of the cover may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to teachings of claimed subject matter without departing from the central concept(s) described herein. Therefore, it is intended that claimed subject matter not be limited to particular examples disclosed, but that such claimed subject matter may also include all aspects falling within appended claims and/or equivalents thereof.

What is claimed is:

1. A cover for use with a trap, comprising:
a shaft to be securable to a movable element of the trap;
an indicator to indicate a change of a state of the trap based, at least in part, on a change in position of the movable element of the trap; and
a housing to cover a hole into which the trap is to be placed, wherein slidable movement of the shaft through an opening of the housing brings about the indication of the change of state of the trap.

2. The cover of claim 1, wherein the housing comprises one or more retainers to removably secure one or more tools.

3. The cover of claim 1, wherein the indicator comprises a flag secured to the shaft.

4. The cover of claim 3, wherein the shaft comprises a substantially conductive portion which, responsive to the change in position of the movable element of the trap, is to conduct an electrical signal, the electrical signal to give rise to an indication of the state of the trap.

5. The cover of claim 4, further comprising a wireless transmitter to transmit a wireless signal responsive to the electrical signal.

6. The cover of claim 4, further comprising an illuminating device to illuminate responsive to the electrical signal.

7. The cover of claim 4, further comprising a solar panel or a storage device or a combination thereof, to provide electrical power to an illuminating device or a wireless transmitter, or a combination thereof.

8. The cover of claim 1, wherein the opening of the housing comprises a substantially vertically oriented sleeve to limit lateral movement of the shaft.

9. The cover of claim 1, the housing further comprising one or more approximately horizontally oriented recesses.

10. The cover of claim 1, wherein the housing comprises a footprint having a width approximately in the range of 15.0 to 35.0 cm.

11. The cover of claim 1, wherein the housing comprises one or more approximately vertically oriented recesses to permit a user to grip the housing.

12. An electronics module for indicating a state of a trap, comprising:
a detector, disposed on a shaft, to detect a change in position of a movable element of the trap via the shaft, the movable element to move responsive to a change of state of the trap; and
an indicator to indicate the detected change in position of the movable element of the trap, the indicator to include a wireless transmitter or an illuminating device, or combination thereof, wherein
the electronics module is to be mounted to a housing to cover the trap.

13. The electronics module of claim 12, wherein the detector comprises a switch to permit current flow responsive to the change in position of the movable element of the trap.

14. The electronics module of claim 12, wherein the wireless transmitter is to transmit an identification code.

15. The electronics module of claim 14, further comprising a code selector to permit selection of the identification code.

16. The electronics module of claim 12, further comprising a timer to repeat the indication of the detected change in position of the movable element of the trap.

17. A cover for use with a trap, comprising:
a coupling to removably secure a shaft to a movable element of the trap;
an indicator to indicate an Open state and a Closed state of the trap, the indicator to include a wireless transmitter or an illumination device or a flag affixed to the shaft, or a combination thereof; and
a housing to cover a hole into which the trap is to be disposed, the housing to include a vertically-oriented sleeve to slidably engage the shaft.

18. The cover of claim 17, wherein the coupling comprises a hook to attach to the movable element of the trap.

19. The cover of claim 17, wherein the indicator comprises a flag affixed to the shaft, the flag to be movable in a direction of gravity responsive to the trap changing from the Open state to the Closed state.

20. The cover of claim 17, wherein the housing comprises one or more spikes to secure the housing to a surface.
